(19) United States
(12) Patent Application Publication
(10) Pub. No.: US 2018/0181581 A1
(43) Pub. Date: Jun. 28, 2018

(54) SYSTEMS AND METHODS FOR IMPLEMENTING OBJECT STORAGE AND FAST METADATA SEARCH USING EXTENDED ATTRIBUTES

(71) Applicant: Lenovo Enterprise Solutions (Singapore) Pte. Ltd., New Tech Park (SG)

(72) Inventor: Michael Neil Condict, Hurdle Mills, NC (US)

(21) Appl. No.: 15/390,012

(22) Filed: Dec. 23, 2016

(51) Int. Cl. G06F 17/30

(52) U.S. Cl. CPC G06F 17/30091; G06F 17/30961; G06F 17/30203

(57) ABSTRACT

A method and system is provided for implementing object storage and fast metadata search using extended attributes in a portable operating system interface (POSIX) file system. The method and system receives data items which contain a value of an object and associates the data item with a set of attributes. The method and system further generates a file having extended attributes in a file system that conforms to the POSIX standard based on the data item and the set of object attributes for use in and based on values of the set of attributes. The method and system also implement efficient queries on the values of the set of attributes.

### TECHNICAL FIELD

The present subject matter relates to unified file and object storage systems. More particularly, the presently disclosed subject matter relates to systems and methods for implementing object storage and fast metadata search using extended attributes.

### BACKGROUND

Current object storage systems manage objects, which include the object data, a unique identifier, and type of metadata associated with the object. Object storage systems provide access to the object level metadata for indexing, managing, and optimizing independently from the data storage.

Various object storage system have integrated file storage systems which allow clients to contact the object metadata servers. These systems are known as unified file and object storage systems. For instance, AMAZON S3™, IBM's SPECTRUM SCALE™, and Open Stack's SWIFT SYSTEM™ allow files to be accessed as an object, but, require an extensive amount of processing must be executed in order to make the file available through the object interface. For example, the storage system may store file data in object storage servers. This type of storage architecture requires the file system client software to interact with these distinct servers and abstract them to present a full file system to users and applications.

Certain file storage systems, including WINDOWS® NTFS file system, LINUX® and UNIX® file systems, support user definable “extended attributes,” which are user-created name-value pairs of metadata which provide additional characteristics associated with a file stored within the file storage system. These extended attributes utilize the same type of metadata as the attributes associated with an object in an object storage system, which raises the possibility of using them to implement an object storage system on top of a file system that supports extended attributes.

However, there are many drawbacks with current unified file and object storage systems. For instance, an object's attributes are not accessible when using the file Application Programming Interface (API) to access the object. Further, these systems do not allow direct local file access to objects, they simply allow networked access via Network File System (NFS) protocols or Common Internet File System (CIFS) protocols. The amount of additional processing in order to make the file available through the object interface is extensive at best. It will reduce the robustness and storage capacity of the overall system, resulting in high cost and expenses in system management and maintenance. Further, legacy applications which operate under POSIX file storage standards are currently unable to access objects within the unified file storage system utilizing UNIX® commands, e.g. “1s” and “cat” commands.

In order to remedy the current problems with unified file and object storage systems, it would be desirable to implement object storage using any existing POSIX file system that supports extended attributes. In the present subject matter, a method is described for doing this local to a single computer system, but those skilled in the art will see that it is easily extended to a distributed object storage system, using well known techniques.

### SUMMARY

According to one aspect of the present subject matter, a method is provided for implementing object storage and fast metadata search using extended attributes in a POSIX file system. The method includes receiving a data item comprising a value of an object. The method also includes associating the data item with a set of attributes. Further, the method includes generating a file having extended attributes in a file system that conforms to the POSIX standard, based on the data item and the set of object attributes for use in and based on values of the set of attributes.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1 is a block diagram of an example system implementing object storage and fast metadata search using extended attributes in a POSIX file system in accordance with embodiments of the present disclosure;

FIGS. 2A and 2B illustrate block diagrams showing an enlarged view of a data item of the system database in accordance with embodiments of the present disclosure;

FIG. 3 is a flow chart of an example method for implementing object storage and fast metadata search using extended attributes in a POSIX file system in accordance with embodiments of the present disclosure;

FIG. 4 is a flow chart of an example method for implementing object storage utilizing a B-Tree indexing function in a POSIX file system in accordance with embodiments of the present disclosure;

FIG. 5 is a flow chart of an example method for implementing object storage by determining permission status and fast metadata search using a B tree indexing function on extended attributes in a POSIX file system in accordance with embodiments of the present disclosure;

FIG. 6 is a block diagram of an example system for executing efficient queries on object attributes and implementing object storage using extended attributes in a POSIX file system in accordance with embodiments of the present disclosure;

FIG. 7 is a block diagram of an example system utilizing a B tree index for executing efficient queries on object attributes and implementing object storage using extended attributes in a POSIX file system in accordance with embodiments of the present disclosure; and

FIG. 8 is a block diagram of an example system utilizing separate B tree files for executing efficient queries on object attributes and implementing object storage using extended attributes in a POSIX file system in accordance with embodiments of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. In another example, the user can use any other suitable user interface of a computing device, such as a keypad, to select the display icon or display object. For example, the user can use a track ball or arrow keys for moving a cursor to highlight and select the display object.

As used herein, the term “memory” is generally a storage device of a computing device. Examples include, but are not limited to, ROM and RAM.

As used herein, the term “display” is generally a display device used for presenting information in visual or tactile form. For example, a display may be a flexible display. Examples include, but are not limited to, an electronic paper based display, and a flexible organic light emitting diode (OLED) display.

As used herein, the term “database” is a collection of tables, objects, files, or other types of data items. The database can be any type of database capable of storing, accessing, or manipulating files or objects such as MySQL®, MICROSOFT® SQL server, ORACLE®, IBM® DB2, AMAZON S3®, or SQLite.

The device or system for performing one or more operations on a memory of a computing device may be software, hardware, firmware, or a combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

The present disclosure is now described in more detail. As previously mentioned above, the present disclosure provides a method is provided for implementing object storage and fast metadata search using extended attributes in a POSIX file system. The method includes receiving a data item comprising a value of an object. Further, the method includes associating the data item with a set of attributes. The method also includes generating a file having extended attributes in a file system that conforms to the portable operating system interface (POSIX) standard based on the data item and the set of object attributes for use in and based on values of the set of attributes.

According to another aspect of the present disclosure, a unified file and object storage system and method is provided in which each file stored in a database can be accessed as an object utilizing object API and vice-a-versa objects may be accessed as files utilizing a file API. The present disclosure addresses many problems known in the art such as the impracticability of searching billions of objects simply to output a few objects with a certain value assigned to them for a given attribute and permitting legacy application that only interpret and understand POSIX file storage to access objects stored in a database without being rewritten or even re-compiled. It also allows object databases to be browsed using file based tools. For example, object databases can be browsed utilizing basic to complex UNIX commands such as, the “CAT,” “CD,” “CHMOD,” or “FTP” commands.

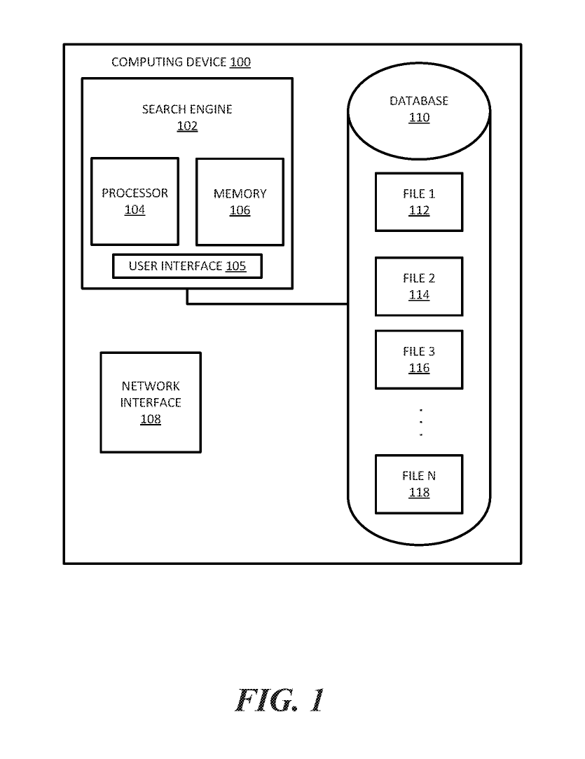

For example, FIG. 1 of the present disclosure illustrates a block diagram of an example system, also known as computing device 100 implementing object storage and fast metadata search using extended attributes in a POSIX file system in accordance with embodiments of the present disclosure. The computing device 100 includes a search engine 102, a processor 104, a memory 106, user interface 105, network interface 108, database 110, and files 1-N 112, 114, 166, and 118. The computing device 100 may be any type of device including hardware, software, firmware, the like, and combinations thereof for implementing the functionality disclosed herein. For example, the computing device 100 may include one or more processors 104 and memory 106 or other suitable non-transitory, computer readable storage medium having computer readable program code for implementing methods in accordance with embodiments of the present disclosure. The processor 104 may be a microcontroller that contains a processor core and programmable input/output peripherals. In embodiments, the processor 104 may be coupled to a user interface 105 for enabling a user or operator to operate and control search engine 102 and/or overall computing device 100. The memory 106 may correspond to a hard disk, a random access memory (RAM), a read-only memory (ROM), an erasable programmable read-only memory (EPROM or Flash memory), a static random access memory (SRAM) or the like. The network interface 108 permits remote communication between the computing device 100 and any other computing device connected in a network, for example, the Internet, a local area network, a wide area network and/or a wireless network. The network may comprise copper transmission cables, optical transmission fibers, wireless transmission, routers, firewalls, switches, gateway computers and/or edge servers. The network interface 105 further receives computer readable program instructions from the network and forwards the computer readable program instructions for storage in the memory of the computing device 100.

With continuing reference to FIG. 1, the search engine 102 may be implemented as software stored in memory 106. Alternatively, the search engine 102 may also be implemented as hardware or firmware in part. As an alternate embodiment, the search engine 102 computer programming instructions may be stored in remote memory (not shown) in another computing device connected via a network, a shared hard drive or as a driver downloaded from the Internet.

The database 110 may be any type of database known in the art which is capable of storing objects and/or files which may also conform to the POSIX standard. As such, the database 110 may also be referred to as a POSIX file system. The POSIX (Portable Operating System Interface) is a set of standard operating system interfaces which are commonly rooted on various UNIX operating system. As shown in FIG. 1, the search engine 102 can gain access to database 110. Although FIG. 1 illustrates a single database 110, search engine 102 may also be integrated into multiple databases of the same or different type. Accordingly, database 110 is configured to store files and/or objects. Each File 1 112 . . . File N 118 is a file which conforms to the POSIX standard. Each file may be created as a file using a file application programming interface or as an object using an object application programming interface.

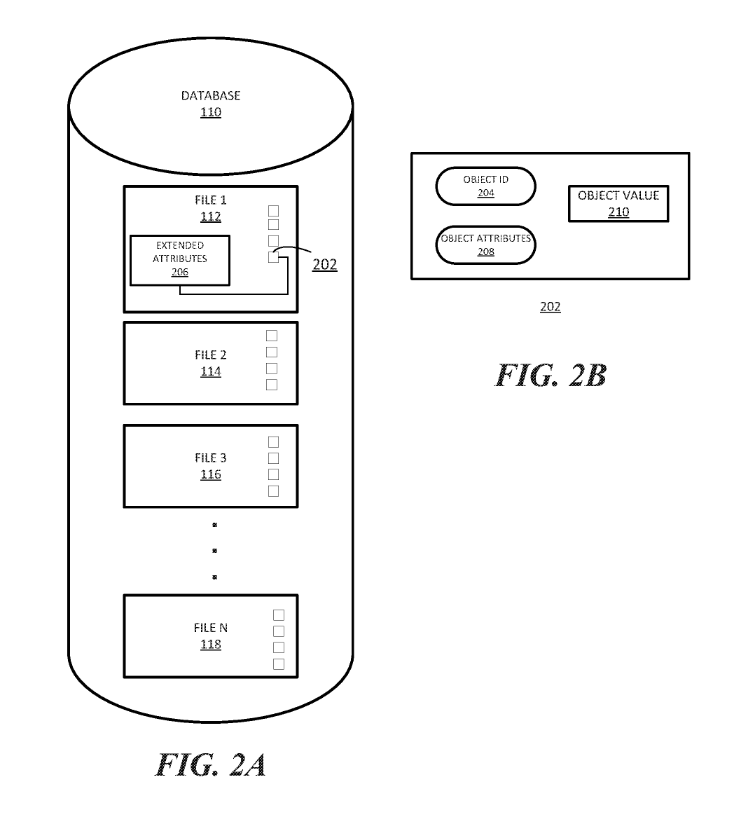

In FIG. 2A and FIG. 2B, a block diagram of the system database, POSIX files, and data items in accordance with embodiments of the present disclosure is illustrated. As shown in FIG. 2A, file 1 112 thru file N 118 contain at least one data item 202. Each file 112 contains a set of zero or more extended attributes 206 associated with the file or its directory. The extended attributes 206 may correspond to user-definable name/value pairs persistently associated with a file or directory. For example, an extended attribute with the name “Location” and a value consisting of an address or GPS coordinates, could be used to tag a JPEG file with the location where a photograph was taken. The extended attribute 206 may correspond to metadata similar to the object attribute 208 associated with the object 202, thus in an alternate embodiment, the present disclosure uses object attribute 208 to implement an object storage with extended attributes 206. Furthermore, any object attributes 208 that are provided by the user or generated by the system become extended attributes 206 of the attached POSIX file 112 as shown in FIGS. 2A and 2B. Accordingly, each file in the database 110 will be accessible as an object using an object API and accessible as a file using a file API. Any extended attribute 206 attached to the file can appear as an object attribute 208 upon a successfully executed query from search engine 102. The computing system 100 maintained attributes for the POSIX file 112 (not shown), such as the last modification date, permissions, owner, and so forth, can also appear as an object attribute 208. The object ID 204 becomes the absolute pathname allowing the object/data item 202 to be accessed by specifying an object id relative pathname. A relative pathname corresponds to a pathname that is relative to the current working directory as described above. For purposes of illustration, the extended attribute 206 is described as a single entity. However, the extended attribute 206 may include multiple extended attributes or a set of extended attributes. Also for illustration purposes, file 1 112 contains the visual depiction of the extended attributes 206, however, each file depicted (e.g. file 2 114, file 3 116 thru file N 118 contains the extended attributes associated with each file as disclosed in FIG. 2A.

FIG. 2B illustrates a block diagram of an example data item 202 according to embodiments of the present disclosure. Referring to FIG. 2B, data item 202 may be any type of data stored, manipulated, saved, or deleted from a file or object storage system. Non-limiting examples of data items may include objects, files, alphanumeric data strings, texts, symbols, numbers, images, sounds, animation characters, or the like. For purposes of illustration, data item 202 corresponds to an object Each object 202 in the database 110 has at least three components: (1) a unique identifier, referred to as an object id 204; (2) an object value 210; and (3) object attributes 208, also known as a set of attributes. The unique identifier, sometimes called a “key” or “object ID” 204 is meant to identify the object within the database 110 and can also be used to efficiently find and operate on the object. In other embodiments of the present disclosure, the object ID 204 may be chosen by the user or automatically generated. The object value 210 is simply an unstructured array of bytes provided by the user (or generated by the computing system 100). In an alternate embodiment, a file in a POSIX file system may be used to implement the object value 210 stored in the POSIX file system. For instance, whenever a new object is stored, a POSIX file is created which will contain an object value 210. The file may also be overwritten if there is an existing object or file which contains the same object name or object ID 204. For instance, when creating a new object, if the new object ID is the pathname of an existing file, the computing device 100 will overwrite that particular file. However, if the user has permission to write to the file or if the user has permission to delete the file and create a new file, then the creation will succeed. As such, common POSIX file protection procedures and semantics are in place and used to determined object permissions. The pathname denoting where the file is created may correspond to the object id 204. If the object id 204 does not begin with a slash “I” then the object can be prefixed with a session-specific “current working directory” effectively forming the pathname of the file. For example, the object id 204 is treated the same way UNIX file creation commands treat a relative or absolute path name. In an alternate embodiment, when a networking protocol is utilized for remote access to the storage system, the current working directory may correspond to the home directory of the user. The home directory may further correspond to the specific directory assigned to each user.

As further shown in FIG. 2B, the object attributes 208 correspond to a set of user-chosen data or system generated data, which are thought of as “metadata” that describe and provide various characteristics of the object 202 (which may also be referred to as a data item). For example, the object attributes 208 can include the data size, name of the creator of the object, the time, place, and location of where the object was created, the size of the object, and the like. The object id 204 becomes the pathname of the File 1 112 thru File N 118.

In other embodiments of the present disclosure, the present disclosure can be formed into a cluster according to any technique for partitioning the object storage across nodes of the cluster as known in the art. For example, a hashing operation may be executed on the object's identifier to calculate a node number.

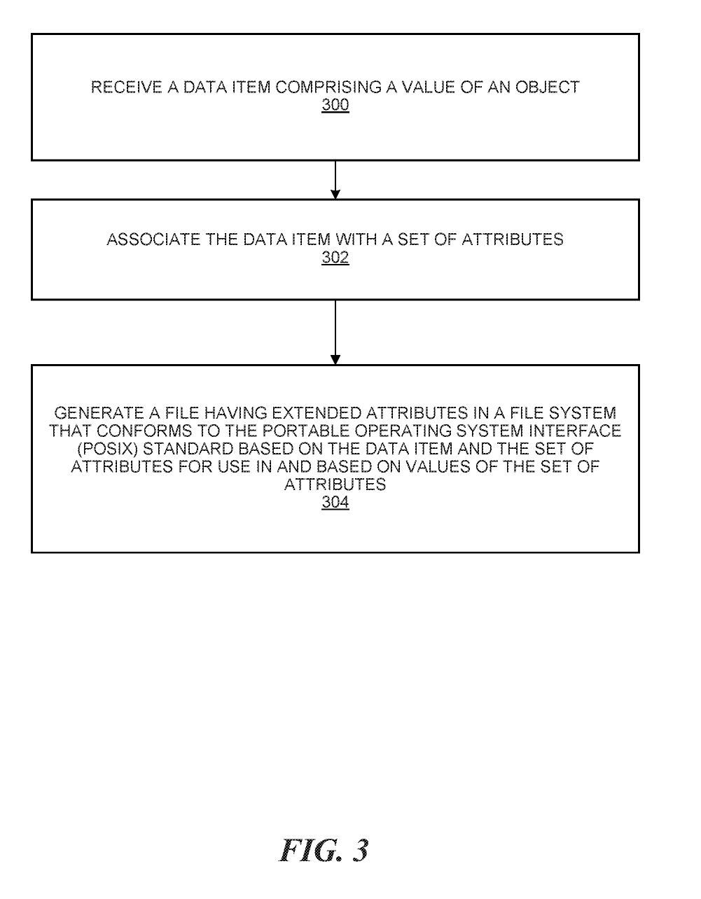

FIG. 3 illustrates a flow chart of an example method for implementing object storage and fast metadata search using extended attributes in a POSIX file system in accordance with embodiments of the present disclosure. At block 300, the method includes a step to receive a data item comprising a value of an object. Followed by a step to associate the data item with a set of attributes at block 302 and generate a file having extended attributes in a file system that conforms to the portable operating system interface (POSIX) standard based on the data item and the set of attributes. In embodiments of the present disclosure, the data item disclosed in block 300 may include an object, file, image, video, or the like. As disclosed in block 302, the set of attributes may correspond to an object attribute or a plurality of object attributes. As discussed above, an object attribute correspond to a set of user-chosen data or system generated data, which are thought of as “metadata” that describe and provide various characteristics of an object data item. For example, the object attributes 208 can include the data size, name of the creator of the object, the time, place, and location of where the object was created, the size of the object, and the like.

Still referring to FIG. 3, at block 304, the method further includes a step to generate a file having extended attributes in a file system that conforms to the POSIX standard based on the data item and the set of attributes for use in and based on values of the set of attributes. As previously stated, the extended attributes are associated with the file in conformance with the POSIX standard. Files which conform to the POSIX standard are files that incorporate and abide by normal POSIX syntax and semantics in a file storage system. The values of the set of attributes correspond to values of an object's attributes, such as the object attribute 208 as disclosed in FIG. 2B. The file generated in block 304 may correspond to any one of Files 1 112 thru File N 118. The data item 202 and set of attributes which are used in and based on values of the set of attributes correspond to the object attributes 208, which may be a value assigned by the user or computing system 100. As previously stated, the value may be any unstructured array of bytes. In an alternate embodiment, the value should conform to the POSIX standard. The value may further include an address, GPS coordinate, age, or any other unstructured or structured array of data associated with an object or data item. Further, when the object attribute becomes an extended attribute associated with the POSIX file as discussed above, the attribute value becomes the value of the extended attribute of the file 112.

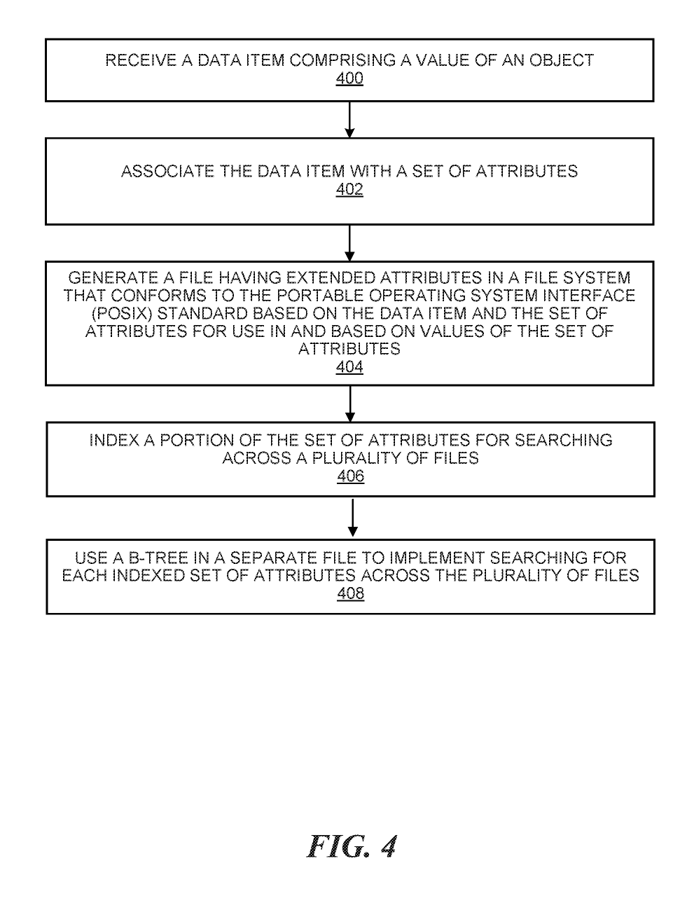

According to FIG. 4, a flow chart of an example method for implementing object storage utilizing a B-tree indexing function in a POSIX file system in accordance with embodiments of the present disclosure is disclosed. At block 400, the method includes steps to receive a data item comprising a value of an object 400, associate the data item with a set of attributes 402, generate a file having extended attributes in a file system that conforms to the POSIX standard based on the data item and the set of attributes for use in and based on values of the set of attributes 404, index a portion of the set of attributes for searching across a plurality of files 406, and use a B-tree in a separate file to implement searching for each indexed set of attributes across the plurality of files 408.

In embodiments of the present subject matter, the steps of indexing a portion of the set of attributes for searching across a plurality of files as stated at block 406 and using a B-tree in a separate file to implement searching for each indexed set of attributes across the plurality of file as disclosed at block 408 is executed in order to implement efficient searches that return all objects where a specified attribute has a specified value or range of values. The files corresponds to the file 1 112 thru file N 118 as disclosed in FIGS. 1 and 2A and explained in detail above. Indexing, as known in the art is the process of collecting, storing, or parsing data in order to simplify fast and accurate information retrieval in database management systems. Indexing has many purposes, however, without an index, search engines would have to scan a millions of file in order to execute an accurate query which would consume unnecessary computing power and time. As disclosed in the present subject matter, an indexing operation is executed utilizing a B-tree data structure which is self-balancing and optimized for database systems which optimize large blocks of data. Indexing using the B-tree as disclosed at blocks 406 and 408 will be discussed in greater detail below.

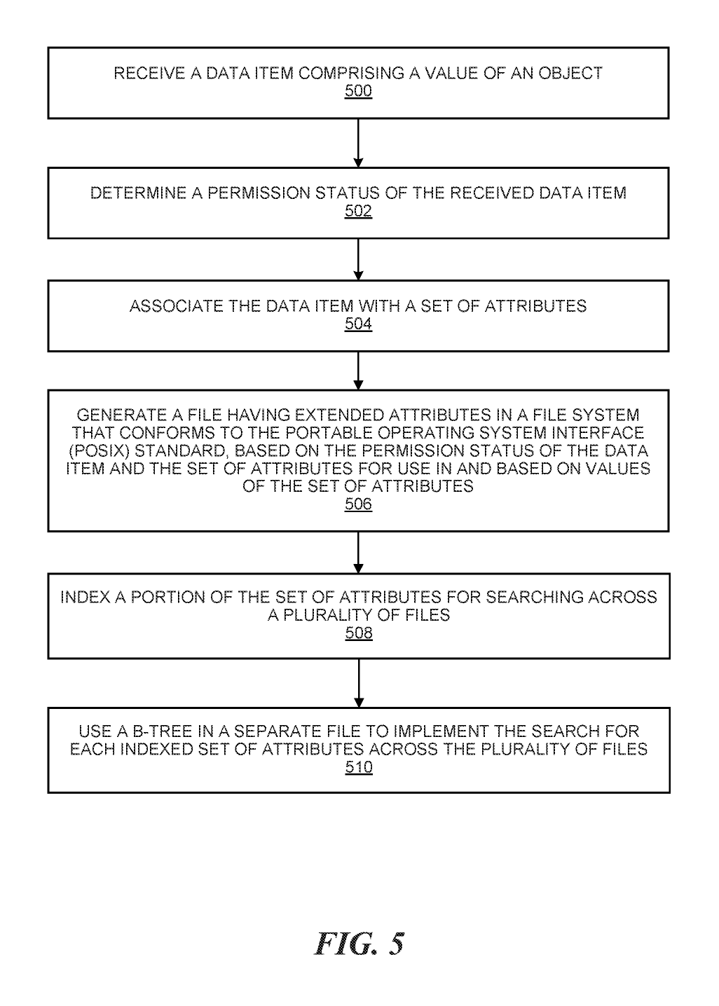

According to FIG. 5, a flow chart of an example method for implementing object storage by determining permission status and fast metadata search using a B tree indexing function on extended attributes in a POSIX file system is disclosed in accordance with embodiments of the present disclosure. At block 500, the method includes steps to receive a data item comprising a value of an object, determine a permission status of the receive data item 502, associate the data item with a set of attributes 504, generate a file having extended attributes in a file system that conforms to the POSIX standard based on the data item and the set of attributes for use in and based on values of the set of attributes 506, index a portion of the set of attributes for searching across a plurality of files 508, and use a B-tree in a separate file to implement searching for each indexed set of attributes across the plurality of files 510. As shown at block 502, permission frameworks which conform to POSIX standards may be incorporated into the overall process in which the data is stored which determines whether a user is able to read, write, delete, access, or store a given file within the plurality of files 112-118 shown in FIGS. 1 and 2A. In an alternate embodiment of the present disclosure, a separate hidden file, which is not accessible to users, may be used to implement the index for each object attribute and associated object id. These particular hidden files could be in a directory that users do not have permission to access as described in block 502.

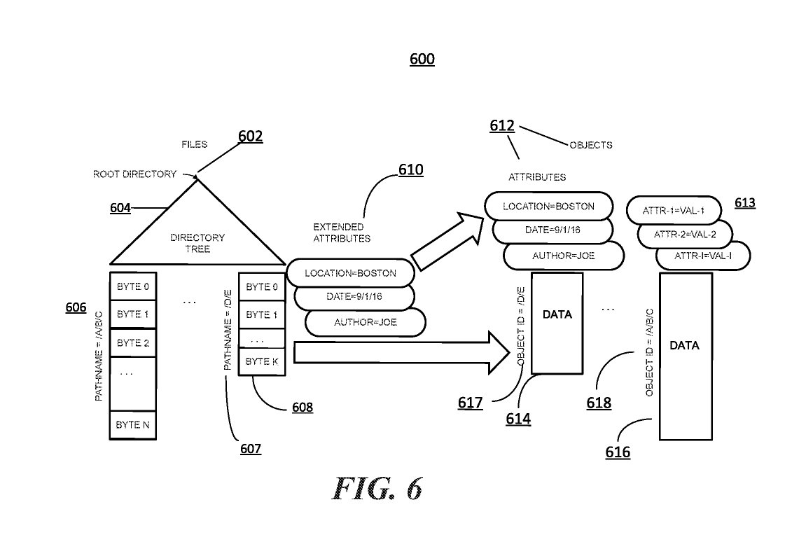

Now turning to FIG. 6, which illustrates a block diagram 600 of an example system for executing efficient queries on object attributes and implementing object storage using extended attributes in a POSIX file system in accordance with embodiments of the present disclosure. The block diagram 600 illustrates POSIX files 602 and object 612 each stored in the unified file object storage system 600. A root directory 604 containing a plurality of files 602 is also depicted and may correspond to the beginning point of the disclosed file storage hierarchy. The root directory 604 conforms to the POSIX standard and any file entered or generated contain character strings which begin with a backlash “/” as shown at the pathname 606 of each file 602 entered. Pathname 606 corresponds to /A/B/C which conforms to the POSIX standard. The value of each file 602 is denoted as byte 0 . . . byte N and pathname 607 byte 0 . . . byte K 608. As further shown, the extended attributes 610 of files 602 as correspond to Location=Boston, Date=Sep. 1, 2016, Author=Joe. As illustrated in FIG. 6, the object attributes 612 depict Location =Boston, Date—Sep. 1, 2016, Author=Joe, meaning, the extended attributes 610 attached to the POSIX file 602 becomes the object attribute 612. Furthermore, the object value 608 with pathname /A/B/C 606 is listed as “1” and “2” becomes the object's value 613 which are depicted as “VAL-1,” and “VAL-2.” Furthermore, the Object id 618 also becomes the pathname 606 and object /D/E becomes the pathname 607. The block diagram 600 describes a non-limiting example of objects within the unified file object storage system of the present disclosure contain object attributes, they become extended attributes that are attached to the POSIX file which contain the object's value. The attribute name provided by the user become the name of the extended attribute of the file and the value becomes the value of the extended attribute of the file. Furthermore, each POSIX file 602 whether created as a file using a file API or created as an object using an object API can be accessible as an object using an object API. Extended attributes attached to the file 602 can appear as object attribute 612.

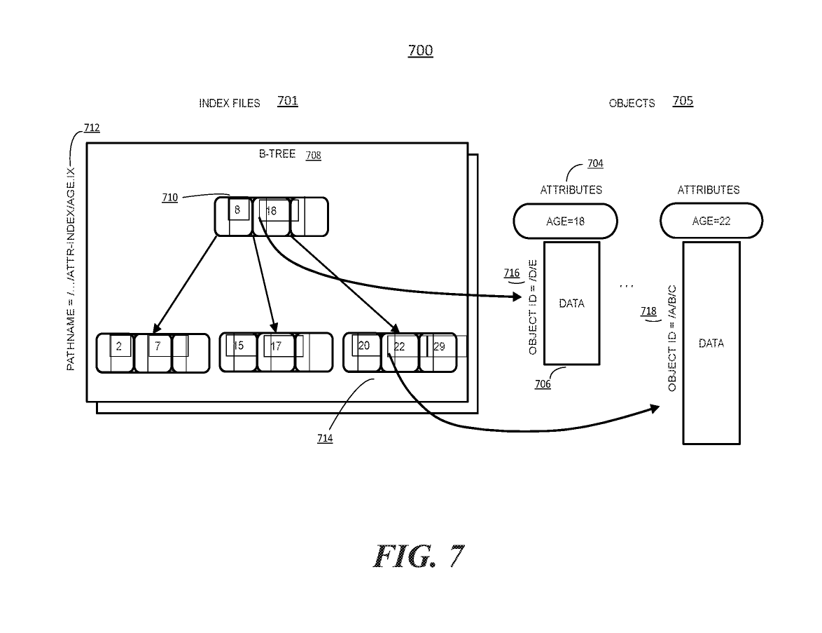

Now turning to FIG. 7, which depicts a block diagram 700 of an example system utilizing a B tree index for executing efficient queries on object attributes and implementing object storage using extended attributes in a POSIX file system in accordance with embodiments of the present disclosure. As shown, index files 701 may be used to implement an indexed search where index files 701 may be stored in a directory B-tree 708 is a b-tree with sufficient width at each node(s) 710 and 714 to fill disk block 706. Each entry in B-tree 708 consist of a value and the pathname 712 of the file for which the named attribute 704 corresponds to the value. For instance, the value represents Age=18 and Age=22. A query on object attribute Age 18 704 is performed by the user specifying a set of attribute-name or in this case, an attribute value pair for a given range such as Age 18 and Age 22 704. When the two values in the index 710 are the same value within each node 714 in the data block 706, only attribute values that have the exact value are considered at match. The data returned by the query operation is a list of object ids 716, 718 with objects whose specified attribute has a value within the specified range. In an alternate embodiment, the purpose for having multiple attribute names or value range pairs in the query is that only objects that match on all the specified attributes should be returned. In conventional indexing, unindexed attributes can appear in queries, but the performance may be slower. However, in this alternate embodiment, performance is enhanced if at least one indexed attribute 710 appears in the query because the set of files and/or objects to be examined is efficiently reduced by filtering the objects to just those that match the first indexed attribute name or values in the query which in turn avoid the need to examine all the files and/or objects within the storage system. According to another embodiment of the present disclosure, in order to keep the index files in sync with the object attributes, all modifications associated with the file system must coincide with a modification of one or more index files. The present unified file system may implement various modification operations in order to execute such modifications. For instance, the operations that cause index files 701 to be update may include deleting a file along with the index entry and attribute values of the file; moving the index entry for a file whose value has been modified to an appropriate place in the index file based on the newly modified value; renaming or updating the all references in all indexes to a file that has been renamed to a different pathname; and adding new entries in the index file for each of the indexed attributes of the new file to a file that has been created and given one or more indexed attributes.

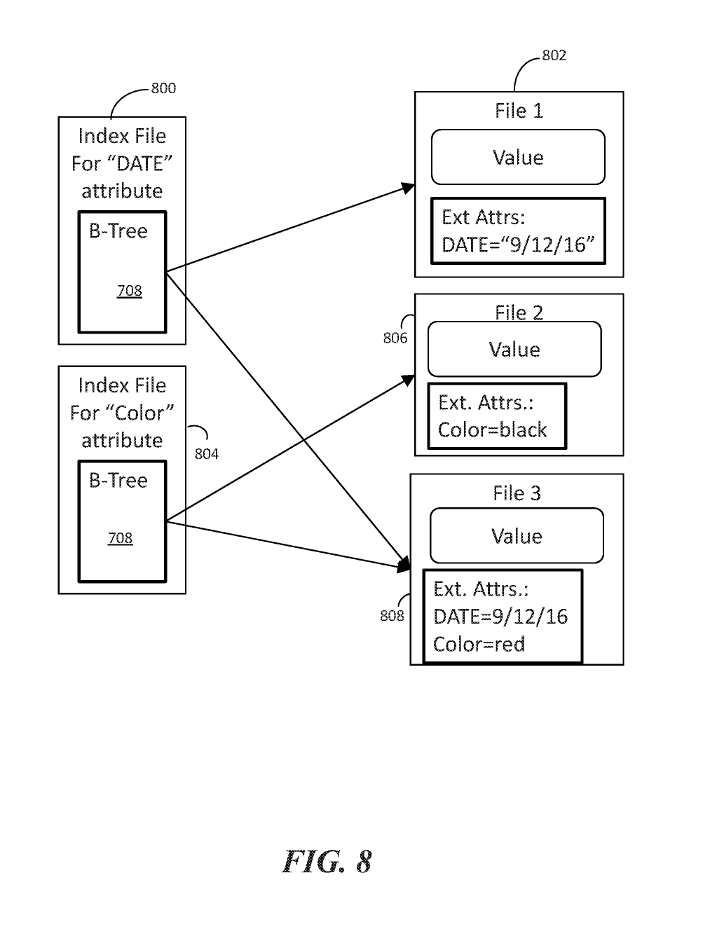

FIG. 8 illustrates a block diagram of an example system utilizing separate B tree files 708 for executing efficient queries on object attributes and implementing object storage using extended attributes in a POSIX file system in accordance with embodiments of the present disclosure. Each separate B-tree 708 index file 800 and 804 are designated one for each attribute name “DATE” and “Color” respectively. As shown in FIG. 8, each index file 800 and 804, are separate index files that contain the B-tree 708 to implement the index. File 1 802, File 2 806, and File 3 808 represent the files within the database 110 which include extended attributes and object values. As further shown in FIG. 8, there is no pointer from the index file 800 for the “DATE” attribute to File 2 806. Further, there is no pointer from the index file 804 for the “Color” attribute to File 1 802. As shown, File 1 802 does not have the attribute “Color” and therefore does not have the pointer from the index file 804.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, systems, and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a data item comprising a value of an object;
associating the data item with a set of attributes; and
generating a file having extended attributes in a file system that conforms to the portable operating system interface (POSIX) standard, based on the data item and the set of object attributes for use in and based on values of the set of attributes.

2. The method of claim 1, wherein the data item is the value of both an object and the file.

3. The method of claim 1, wherein each object attribute comprises an extended attribute of the file.

4. The method of claim 3, wherein the extended attribute comprises an alpha-numeric name and an unstructured array of data as its value.

5. The method of claim 1, further comprising indexing some of the object attributes for searching across a plurality of files.

6. The method of claim 6, further comprising using a b-tree in a separate file to implement the search for each indexed object attribute.

7. The method of claim 7, wherein each indexed file contains object-attribute values, and wherein each object-attribute value includes a pathname of the file containing that value for the indexed object attribute.

8. The method of claim 7, further comprising querying on an object attribute using one of a specified value or a specified range of values.

9. The method of claim 8, further comprising performing a search based on the specified value or the specified range of values of the extended object attribute.

10. The method of claim 1, wherein the file can be overwritten when the POSIX file is already existing in the POSIX storage system.

11. The method of claim 1, further comprising generating the POSIX file by use of a file application programming interface or object application programming interface.

14. The method of claim 1 further comprising:
determining the permission status of the received data item; and
generating at least one POSIX file as an object file based on the permission status of the received data item.

15. The method of claim 13, wherein the permission status corresponds to permission to write, read, delete, or create a new POSIX file.

16. The method of claim 1, further comprising transmitting the file over a computer network using network file systems (NFS), common internet file systems (CIFS), file transfer protocol (FTP), or transfer control protocol and the internet protocol (TCP/IP).

17. A system comprising:
a computing device, wherein the computing device comprises:
a database configured to store a plurality of Portable Operating System Interface (POSIX) files, each POSIX file including a set of object attributes; and
a search engine configured to:
receive a value for locating one or more POSIX files among the plurality of POSIX files; and
use the value to identify a POSIX file among the plurality of POSIX files that has an object attribute matching the value.

18. The system of claim 17, wherein the data item is the value of both an object and the file.

19. The system of claim 17, wherein each object attribute comprises an extended attribute of the file.

20. A computer program product comprising a computer readable storage medium that is not a signal having program instructions embodied therewith, the program instructions executable by a computing device to:
receive, by the computing device, a data item comprising a value of an object;
associate, by the computing device, the data item with a set of attributes; and
generate, by the computing device, a file having extended attributes in a file system that conforms to the portable operating system interface (POSIX) standard, based on the data item and the set of object attributes for use in and based on values of the set of attributes.
